(19) United States
(12) Patent Application Publication
(10) Pub. No.: US 2023/0108282 A1
(43) Pub. Date: Apr. 6, 2023

(54) PESTICIDE COMPOSITION FOR CROP CARE AND PROTECTION

(71) Applicant: ALPHA BIOPESTICIDES LIMITED, Cambridge (GB)

(72) Inventor: Alfeo Vecchi, Cambridge (GB)

(73) Assignee: ALPHA BIOPESTICIDES LIMITED, Cambridge (GB)

(21) Appl. No.: 17/905,652

(22) PCT Filed: Mar. 3, 2021
(86) PCT No.: PCT/EP2021/055381

§ 371 Date: Sep. 6, 2022

(30) Foreign Application Priority Data
Mar. 6, 2020 (IT) 102020000004816

(51) Int. Cl. A01N 37/06; A01N 25/04; A01N 25/30; A01P 7/04

(52) U.S. Cl. CPC A01N 37/06; A01N 25/04; A01N 25/30; A01P 7/04

(57) ABSTRACT

A pesticide composition comprising a C₁₂-C₂₄ fatty acid in an emulsion, as well as a process for preparing the same and uses for protecting crop against pests, such as insects, nematodes, fungi, oomycetes and bacteria, are disclosed.

### FIELD OF THE INVENTION

The present invention concerns a pesticide composition comprising a C₁₂-C₂₄ fatty acid in an emulsion, as well as a process for preparing the same and uses for protecting crop against pests, such as insects, nematodes, fungi, oomycetes and bacteria.

### STATE OF THE ART

Insects, fungi and bacteria can cause substantial damage to crops with significant losses in quality and quantity.

The insecticides are of great importance in agriculture although there are strong concerns in the use of plant protection products, on human health and environmental impact, especially when said plant protection products are from synthetic chemical preparations. Therefore, there is a great effort in the research of new agrochemical formulations which have reduced risk on human health and the environment.

It is therefore an object of the present invention to provide a product for plant care and protection, which results in a more eco-friendly product, without reducing the insecticide, nematicide, fungicide, oomycocide and bactericide effectiveness.

### SUMMARY OF THE INVENTION

The above object has been achieved by a pesticide composition comprising a C₁₂-C₂₄ fatty acid in an emulsion, as claimed in claim 1.

The term “pesticide” or “pesticide composition” denotes a substance that is meant to control pests. The term “pest” or “pests” includes insects, plant pathogens, weeds, molluscs, birds, mammals, fish, nematodes (roundworms), and microbes that destroy property, cause nuisance, or spread disease, or are disease vectors. Target pests for the present invention are preferably insects, nematodes, fungi, oomycetes and bacteria.

In a further aspect, the present invention concerns the use of the pesticide composition for protecting crops against insects, nematodes, fungi, oomycetes and bacteria.

In this regard, the present invention also concerns a method of protecting crop against insects, nematodes, fungi, oomycetes and bacteria, said method comprising the steps of:

i) providing the pesticide composition,

ii) diluting said composition in water to obtain a diluted solution,

iii) applying the diluted solution to crop.

The term “crop” denotes a plant or a plant product that can be grown and harvested extensively for profit or subsistence, thus including cereals, vegetables, fruits, and flowers.

In an additional aspect, the present invention concerns a plant-protection product comprising the pesticide composition, and agro-chemical additives.

In another aspect, the present invention concerns a process of preparing the pesticide composition.

### BRIEF DESCRIPTION OF THE FIGURES

The characteristics and the advantages of the present invention will become apparent from the following detailed description, from the working examples provided for illustrative purposes, and from the annexed Figures wherein:

FIGS. 1-3 show the pest mortality results achieved by three different formulations according to the present invention, after the tests performed in Example 2, with respect to a comparative product and the untreated control;

FIG. 4 shows the aphid mortality caused on leaves by the tested formulations at different concentrations with respect to a comparative product and the untreated control, as per Example 2;

FIGS. 5A and 5B show the aphid susceptibility towards the tested formulations, as per Example 2;

FIG. 6 shows the mean efficacy measured in 4 replicates and at 3 end-points (24, 48 and 72 HAA) for the different formulations, as per Example 2; and

FIG. 7 shows the efficacy against the Green Peach-Potato Aphid observed for two of the tested formulations, as per Example 2.

### DETAILED DESCRIPTION OF THE INVENTION

The subject of the invention therefore is a pesticide composition comprising:
1) at least a C₁₂-C₂₄ fatty acid,
2) at least a vegetal oil, and
3) at least an ethoxylated or propoxylated surfactant, or at least a polyoxyethylene emulsifier, or a mixture thereof,

It has been found that the above composition allows the fatty acid to be available for the intended uses without the need of being salified, because the composition of the invention results in a uniform emulsion that can be easily diluted in water, despite the hydrophobic nature of the main components.

Moreover, the vegetal oil gives the fatty acids greater stability and prevents the fatty acids from becoming rancid over time.

This results in a very stable pesticide composition which is more environmentally sustainable and also more cost-effective.

With the term “C₁₂-C₂₄ fatty acid”, it is meant lauric acid (C12), tridecylic acid (C13), myristic acid (C14), pentadecylic acid (C15), palmitic acid (C16), margaric acid (C17), stearic acid (C18), oleic acid (C18:1), linoleic acid (C18:2), α-linolenic acid (C18:3), γ-linolenic acid (C18:3), nonadecylic acid (C19), arachidic acid (C20), heneicosanoic acid (C21), behenic acid (C22), tricosylic acid (C23), lignoceric acid (C24), oleic acid (C18:1), linoleic acid (C18:2), α-linolenic acid (C18:3), γ-linolenic acid (C18:3), stearidonic acid (C18:4), eicosapentaenoic acid (C20:5), docosahexaenoic acid (C22:6), dihomo-γ-linolenic acid (C20:3), arachidonic acid (C20:4), adrenic acid (C22:4), palmitoleic acid (C16:1), vaccenic acid (C18:1), paullinic acid (C20:1), elaidic acid (Ctrans-18:1), gondoic acid (C20:1), erucic acid (C22:1), nervonic acid (C24:1), mead acid (20:3), or a mixture thereof.

Said fatty acids are preferably naturally occurring fatty acids, such as those from plants and vegetables.

Preferably, said at least a fatty acid is a C₁₆-C₂₀ fatty acid.

More preferably, said at least a C₁₆-C₂₀ fatty acid is linoleic acid (C18:2), γ-linolenic acid (C18:3), palmitoleic acid (C16:1), vaccenic acid (C18:1), paullinic acid (C20:1), oleic acid (C18:1), elaidic acid (Ctrans-18:1), or a mixture thereof.

In preferred embodiments, said C₁₆-C₂₀ fatty acid is oleic acid.

Vegetal oil or vegetable oil is an oil extracted from seeds or, less often, from other parts of fruits. Vegetable oils are mixtures of triglycerides (https://en.wikipedia.org/wiki/Vegetable_oil). A triglyceride (TG, triacylglycerol, TAG, or triacylglyceride) is an ester derived from glycerol and three fatty acids (from tri- and glyceride) (https://en.wikipedia.org/wiki/Triglyceride). Therefore, for the purposes of the present invention, with the term “vegetal oil” or “vegetable oil”, it is meant the triglyceride component of the same, which typically is up to 99% of the oil, the remaining components being in negligible concentrations.

Preferably, said vegetal oil is rapeseed oil, colza oil, soybean oil, seed oil, olive oil, wheat germ oil, palm oil, coconut oil, sesame oil, babassu oil, castor oil, peanut oil, cottonseed oil, hemp oil, grape seed oil, tea tree oil (melaleuca oil), linseed oil, walnut oil, poppy oil, maize oil, borage oil, kukui oil, sunflower oil, groundnut oil, canola oil, anchusa oil, or a mixture thereof.

Preferably, said vegetal oil comprises colza oil, olive oil, or a mixture thereof.

More preferably, said vegetal oil is colza oil, sesame oil, olive oil, or a mixture thereof.

In preferred embodiments, said vegetal oil is colza oil, or a mixture of colza oil with one or more oils selected from rapeseed oil, soybean oil, seed oil, olive oil, wheat germ oil, palm oil, coconut oil, sesame oil, babassu oil, castor oil, peanut oil, cottonseed oil, hemp oil, grape seed oil, tea tree oil (melaleuca oil), linseed oil, walnut oil, poppy oil, maize oil, borage oil, kukui oil, sunflower oil, groundnut oil, canola oil, and anchusa oil.

In alternative preferred embodiments, said vegetal oil is olive oil, or a mixture of olive oil with one or more oils selected from rapeseed oil, soybean oil, seed oil, colza oil, wheat germ oil, palm oil, coconut oil, sesame oil, babassu oil, castor oil, peanut oil, cottonseed oil, hemp oil, grape seed oil, tea tree oil (melaleuca oil), linseed oil, walnut oil, poppy oil, maize oil, borage oil, kukui oil, sunflower oil, groundnut oil, canola oil, and anchusa oil.

With the term “ethoxylated or propoxylated surfactant”, it is meant a surfactant which is ethoxylated, propoxylated, or both ethoxylated and propoxylated.

Preferably, suitable ethoxylated or propoxylated surfactants are polyethoxylated fatty alcohols, polyethoxylated castor oils, polyethoxylated distyrylphenols, polyethoxylated tristyryl phenols, polyethoxylated phosphorylated tristyryl phenols, polyethoxylated sulphated tristyryl phenols, polyethoxylated sorbitan esters, alkyl polyglycosides, polyethoxylated-polypropoxylated aliphatic alcohols, and mixtures thereof.

There are preferred polyethoxylated castor oils having an ethoxylation number of 15-40, preferably 25-35; polyethoxylated distyrylphenols having an ethoxylation number of 12-25, preferably 15-20; polyethoxylated tristyrylphenols having an ethoxylation number of 15-40, preferably 16-25.

Preferably, said at least an ethoxylated surfactant is a C₁₂-C₂₄ fatty acid salt of seed oil ethoxylate, a fatty alcohol ethoxylate, or a mixture thereof.

In preferred embodiments, said at least an ethoxylated surfactant is castor oil ethoxylate oleate, tridecyl alcohol ethoxylate, or a mixture thereof.

With the term “polyoxyethylene emulsifier”, it is meant an emulsifier comprising at least a polyoxyethylene moiety.

Preferably, suitable polyoxyethylene emulsifiers are polyoxyethylene alkyl phenyl ether phosphates, polyoxyethylene phenylphenol alkyl ether phosphate, styrene polyoxyethylene ether sulfate ammonium salt, alkyl diphenyl ether disulfonic acid and salts thereof, benzyl dimethyl phenol polyoxyethylene ethers, polyoxyethylene phenyl phenol ethers, alkylphenol formaldehyde resin polyoxyethylene ethers, phenethyl phenol formaldehyde resin polyoxyethylene ethers, phenethyl polyoxyethylated polypropylene ethers, ethylene oxide-propylene oxide block copolymers, polyoxyethylene alkyl phenyl ethers, polyoxyethylene castor oil polyoxyethylene ethers, polyoxypropylene alkyl aryl polyoxyethylene ethers, alkylaryl polyoxyethylene polyoxypropylene ethers, sorbitan polyoxyethylene ethers, polyoxyethylene fatty alcohol ethers, and mixtures thereof.

In more preferred embodiments, the pesticide composition comprises:
1) at least a C₁₆-C₂₀ fatty acid,
2) colza oil, sesame oil, or a mixture thereof, and
3) castor oil ethoxylate oleate, tridecyl alcohol ethoxylate, or a mixture thereof.

In preferred embodiments, the weight ratio between the 1) at least a C₁₂-C₂₄ fatty acid and 2) at least a vegetal oil is of 1:2 to 5:1, preferably 1:1.1 to 3:1, more preferably 1:1 to 2:1.

In other embodiments, the weight ratio between the 2) at least a vegetal oil, and 3) at least an ethoxylated or propoxylated surfactant, or at least a polyoxyethylene emulsifier, or a mixture thereof, is of 1:2 to 5:1, preferably 1:1 to 3:1, more preferably 1:1 to 2:1.

In other embodiments, the weight ratio between the 1) at least a C₁₂-C₂₄ fatty acid, and 3) at least an ethoxylated or propoxylated surfactant, or at least a polyoxyethylene emulsifier, or a mixture thereof, is of 1:1 to 10:1, preferably 2:1 to 5:1, more preferably 2:1 to 3:1.

Particularly preferred are those pesticide compositions wherein:

the weight ratio between the 1) at least a C₁₂-C₂₄ fatty acid and 2) at least a vegetal oil is of 1:2 to 5:1, preferably 1:1.1 to 3:1, more preferably 1:1 to 2:1,

the weight ratio between the 2) at least a vegetal oil, and 3) at least an ethoxylated or propoxylated surfactant, or at least a polyoxyethylene emulsifier, or a mixture thereof, is of 1:2 to 5:1, preferably 1:1 to 3:1, more preferably 1:1 to 2:1, and

the weight ratio between the 1) at least a C₁₂-C₂₄ fatty acid, and 3) at least an ethoxylated or propoxylated surfactant, or at least a polyoxyethylene emulsifier, or a mixture thereof, is of 1:1 to 10:1, preferably 2:1 to 5:1, more preferably 2:1 to 3:1.

In further embodiments, the 1) at least a C₁₂-C₂₄ fatty acid is in an amount up to 70 wt %, based on the weight of the composition, preferably 30-60 wt %.

In other preferred embodiments, the 2) at least a vegetal oil is in an amount up to 50 wt %, based on the weight of the composition, preferably 20-40 wt %.

In other embodiments, the 3) at least an ethoxylated or propoxylated surfactant, or at least a polyoxyethylene emulsifier, or a mixture thereof is in an amount up to 30 wt %, based on the weight of the composition, preferably 10-25 wt %.

Particularly preferred are those pesticide compositions comprising:
1) 40-60 wt % of at least a C₁₂-C₂₄ fatty acid,
2) 25-35 wt % of at least a vegetal oil, and
3) 15-25 wt % of at least an ethoxylated or propoxylated surfactant, or at east a polyoxyethylene emulsifier, or a mixture thereof,

based on the weight of the composition.

In more preferred embodiments, the pesticide composition comprises:
1) 40-60 wt % of at least a C₁₆-C₂₀ fatty acid,
2) 25-35 wt % of colza oil, sesame oil, or a mixture thereof, and
3) 15-25 wt % of at least an ethoxylated surfactant.

In the most preferred embodiments, the pesticide composition comprises:
1) 48-53 wt % of oleic acid,
2) 28-33 wt % of colza oil, sesame oil, or a mixture thereof, and
3) 17-22 wt % of castor oil ethoxylate oleate, tridecyl alcohol ethoxylate, or a mixture thereof.

In additional embodiments, the pesticide composition consists essentially of 1) at least a C₁₂-C₂₄ fatty acid, 2) at least a vegetal oil, and 3) at least an ethoxylated or propoxylated surfactant, or at least a polyoxyethylene emulsifier, or a mixture thereof, as above described. For the purposes of the present invention, the expression “consists essentially of” means that the components 1)-3) are the only active ingredients against pests, which are present in the pesticide composition.

In further embodiments, the pesticide composition consists of 1) at least a C₁₂-C₂₄ fatty acid, 2) at least a vegetal oil, and 3) at least an ethoxylated or propoxylated surfactant, or at least a polyoxyethylene emulsifier, or a mixture thereof, as above described.

It should be understood that all aspects identified as preferred and advantageous for the pesticide composition comprising the components 1)-3) are to be deemed as similarly preferred and advantageous also for the pesticide composition consists essentially of the components 1)-3), and for the pesticide composition consists of the components 1)-3).

In a further aspect, the present invention relates to the use of the pesticide composition as above described, for protecting crop against insects, nematodes, fungi, oomycetes and bacteria.

Particularly, this composition has proved to be effective against insects.

Therefore, preferably, the present invention refers to the use of the composition above described for protecting crop against insects.

The term “insect” refers to any embryonic, larval, nymph or adult form of the arthropod classes Arachnida or Insecta. Insecta includes Coleoptera (e.g. Leptinotarsa decemlineata, Diabrotica spp.), Diptera (e.g. Hylemya platura), Hemiptera (e.g. Lygus spp., Aphis gossypii, Homoptera such as Trialeurodes abutilonea, Bemisia tabaci; Heteroptera such as Nezara viridula), Hymenoptera, and Lepidoptera (e.g. Helicoverpa armigera, Ostrinia nubilalis).

As stated above, the composition is effective even at very reduced amounts. In other words, the pesticide composition is effective at very low concentrations, i.e. less than 10 g/100 l of water, preferably 0.1-5 g/100 l of water.

In this regard, the present invention also concerns a method of protecting crop against insects, nematodes, fungi, oomycetes and bacteria, said method comprising the steps of:

i) providing the pesticide composition,

ii) diluting said composition in water to obtain a diluted solution,

iii) applying the diluted solution to crop.

Preferably, this method is for protecting crop against insects.

Preferably, the application of the diluted solution to crop, in step iii), is performed by spraying the solution on crop, at different times during the development of the crop, according to the parameters of pest growth.

Preferably, the solution is applied at least once a year; more preferably, 2 to 6 times a year; even more preferably 3 times a year.

In an additional aspect, the present invention also concerns a plant-protection product comprising the pesticide composition, and agro-chemical additives.

Suitable additives are pH adjusters, acidity adjusters, water hardness adjusters, mineral oils, vegetal oils, fertilizers, leaf manures, and combinations thereof.

In another aspect, the present invention relates to a process of preparing the pesticide composition as above described, said process comprising the steps of:
a) providing the components 1)-3), and
b) mixing until a pesticide composition in the form of a uniform emulsion is achieved.

It should be appreciated that no solvents are needed, to prepare the pesticide composition of the present invention.

It should be understood that all aspects identified as preferred and advantageous for the pesticide composition are to be deemed as similarly preferred and advantageous also for the process of preparation, the plant-protection product, the uses of the same, and the method of protecting crop.

It should be also understood that all the combinations of preferred aspects of the pesticide composition of the invention, as well as of process of preparation, the plant-protection product, the use and the method, as above reported, are to be deemed as hereby disclosed.

Below are working examples of the present invention provided for illustrative purposes.

### EXAMPLES

### Example 1

The following compositions were prepared, having the ingredients reported in the table below.

| | | | | tridecyl | castor oil |
|---|---|---|---|---|---|
| | oleic | sesame | colza | alcohol | ethoxylate |
| | acid | oil | oil | ethoxylate | oleate |
| Example 1A | 50 wt % | 31 wt % | | 19 wt % | |
| (SS) | | | | | |
| Example 1B | 50 wt % | 31 wt % | | | 19 wt % |
| (SV) | | | | | |
| Example 1C | 50 wt % | | 31 wt % | | 19 wt % |
| (CV) | | | | | |

### Example 2. Efficacy Test against Aphis gossypii (Homoptera: Aphididae), Commonly Known as Cotton Aphid or Melon Aphid

### Chemicals

The following chemical formulations were tested:

1. ABP 111 SS (Ex. 1A)

2. ABP 111 SV (Ex. 1B)

3. ABP 111 CV (Ex. 1C)

Each formulation was tested at the following concentrations 0.5%, 1% and 2%.

The comparative product ABP 617, i.e. potassium oleate, at 1% was used as treated control.

### Experimental Procedure

The insecticidal solutions were prepared by stirring the formulation with a magnetic agitator for 3 minutes at 300 rpm. The solutions were prepared by using tap water.

For this bioassay, a replicate consisted of twelve (12) coetaneous young adults (<48 h old) feeding on a fresh young zucchini plant (cv “Bianca di Trieste, 1 week old) that were directly sprayed with chemicals through a 2 L hand sprayer (to mimic real exposure conditions) and dry in laboratory. The aphid mortality was assessed under a stereomicroscope 24 hours after the exposure.

Five replicates were conducted per each concentration of the chosen formulation. Among the treatments, an untreated control was also included. Also, the potential phytotoxic effect of the tested formulations was assessed by taking pictures of the sprayed plants 1 week later.

The toxicological bioassays were performed under standardised environmental conditions in a climatic cabinet kept at 25±1° C., 60±5% R.H. and 14L:10D h photoperiod.

### Results

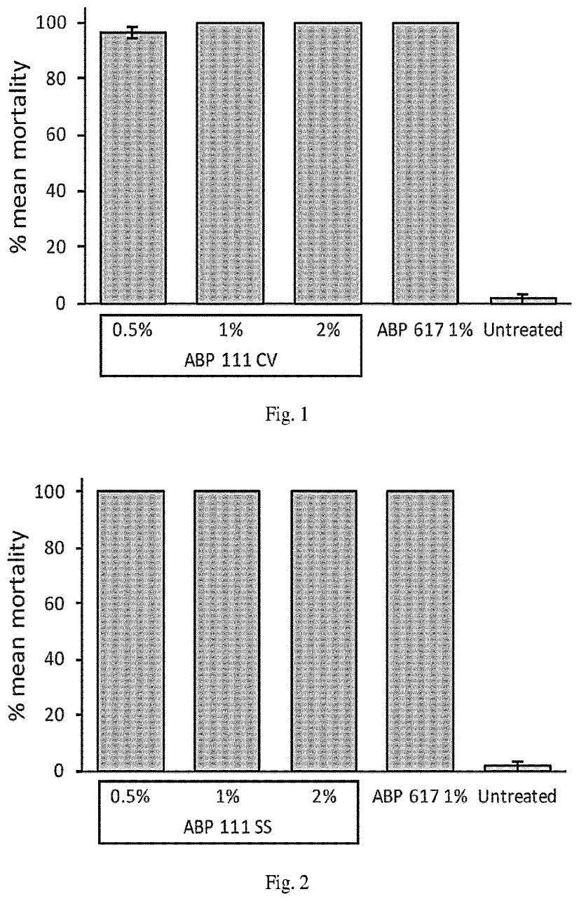

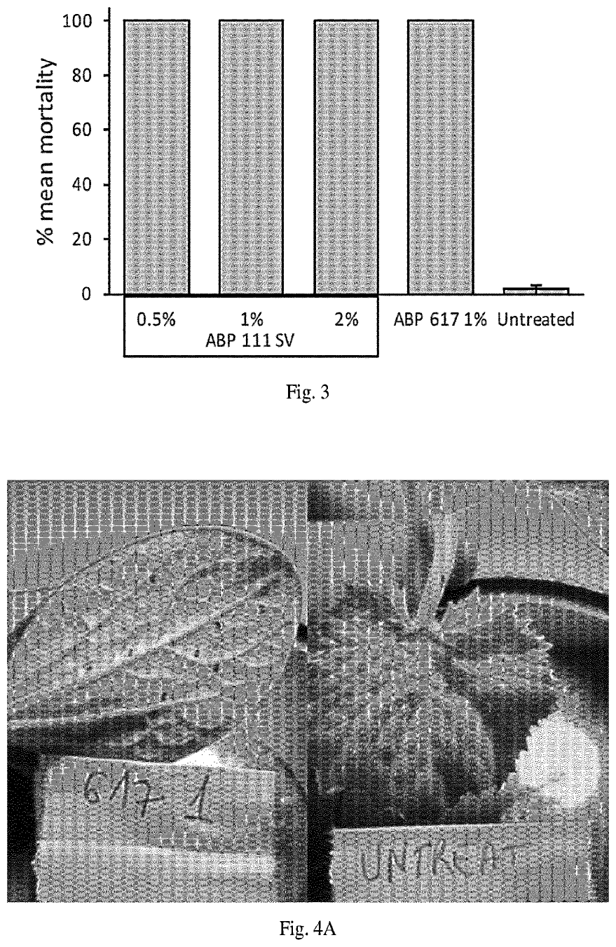

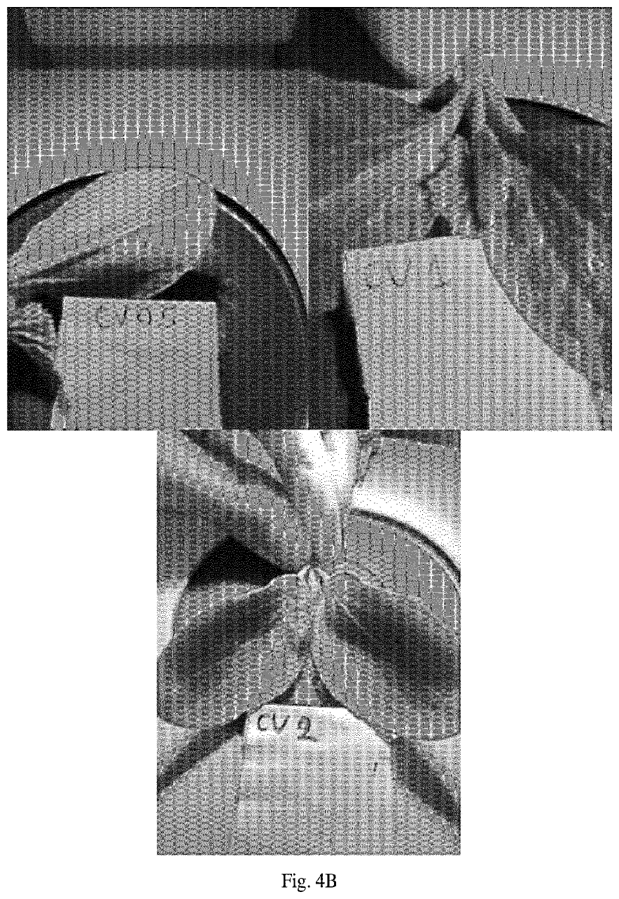

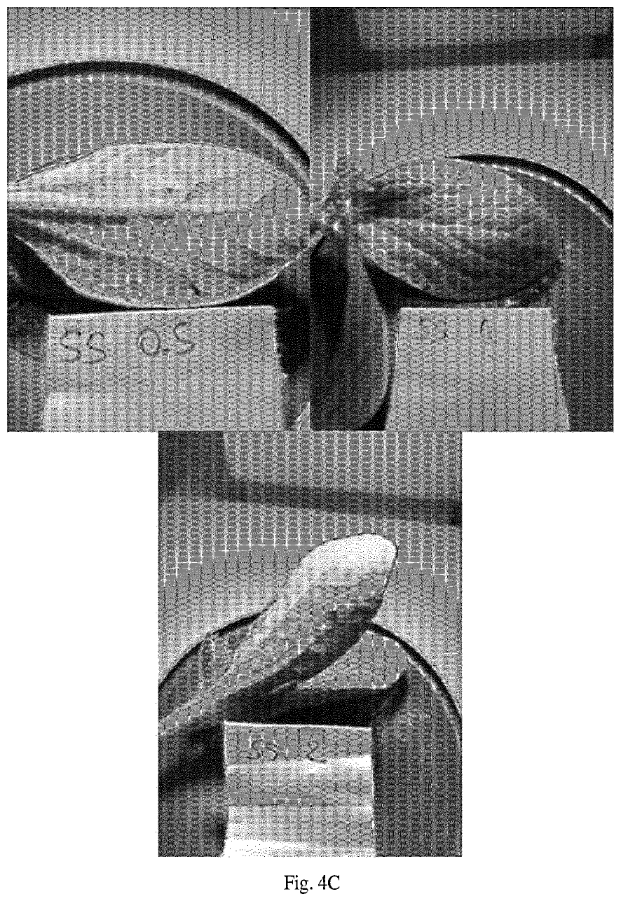

By topic exposure, all the tested formulations at all the tested concentrations caused significant mortality towards the target pest, in comparison to the untreated control (FIGS. 1-3). The mortality caused by the tested formulations at different concentrations was comparable to the treated control (ABP 617 at 1%). Dead aphids showed necrotic body (FIG. 4A-D).

### Example 3. Efficacy Comparison of Different Compositions of the Invention against an Insecticide Resistant Strain of Myzus persicae

### 1. Study Description

The green peach-potato aphid (GPA) (Myzus persicae) is a serious pest of many different crops worldwide. Due to the extremely high selection pressure produced by insecticide applications, many populations with several resistance mechanisms have been selected.

Resistance mechanisms usually coexist in the same specimen and literature data reporting the importance of “metabolic” and “target site” resistance is increasing.

The efficacy of several insecticides is affected in the field by target site and metabolic resistance. Nevertheless, the addiction of different molecules in the formulations can increase the efficacy and can allow to reduce insecticide application dose.

The aim of the study is to compare using a single dose response bioassay with topical application the efficacy against a resistant Myzus persicae clone of two new formulations of ABP 111 which efficacy was evaluated in the previous example.

### 2. Materials and Methods

### 2.1 Aphids

One clone of M. persicae (Mp_92H6) was selected from those available in the rearing facilities of the Department of Sustainable Crop Production (DI.PRO.VE.S.), Università Cattolica del Sacro Cuore (Piacenza). Aphids were maintained on pea-seedlings (cv Meraviglia d'Italia) in controlled environmental conditions (21±0.5° C. with a 16:8 h light:dark photoperiod) to be reared as parthenogenetic lineage.

Clone Mp_92H6 was originally established from a single parthenogenetic female of a resistant population collected in 2010 in Cesena (Emilia-Romagna, Italy) in a peach orchard. It presents various combinations of insecticide resistance mechanisms: targetsite resistance to pyrethroids, due to the presence of kdr (L1014F) and s-kdr (M918T) mutations, both in homozygous form; metabolic resistance to pyrethroids and neonicotinoids, deduced by previous bioassays performed in the presence of the synergist piperonyl butoxide (PBO)¹ and confirmed by laboratory tests. Total esterase activity was assessed with a colorimetric assay and calculated to be 0.376±0.032 nmoles μg⁻¹ min¹, classified as ‘high resistant’ (R2) to organophosphates; furthermore, qPCR analysis showed a 50-fold change in copy number of CYP6CY3 gene, encoding for the P450 monooxygenase CYP6CY3, known to metabolise neonicotinoids. [¹ Panini M, Dradi D, Marani G, Butturini A & Mazzoni E (2014) Detecting the presence of target-site resistance to neonicotinoids and pyrethroids in Italian populations of Myzus persicae. Pest Manag Sci, 70: 931-938.Panini M, Anaclerio M, Puggioni V, Stagnati L, Nauen R & Mazzoni E (2015) Presence and impact of allelic variations of two alternative s-kdr mutations, M918T and M918L, in the voltage-gated sodium channel of the green peach aphid Myzus persicae. Pest Manag Sci, 71: 878-884.]

### 2.2 Compounds

The following formulations (fatty acids; 451 g L⁻¹) have been investigated:

(ABP 111 SS) or (ABP 111 ST)—Ex. 1A

(ABP 111 CV)—Ex. 1C

(ABP 111 SV)—Ex. 1B

All the above-mentioned products were supplied by Alpha BioPesticides Limited.

The formulated products were prepared using double distilled water (11 mL L⁻¹, corresponding to an active ingredient content of 4.961 g L⁻¹).

### 2.3 Bioassays

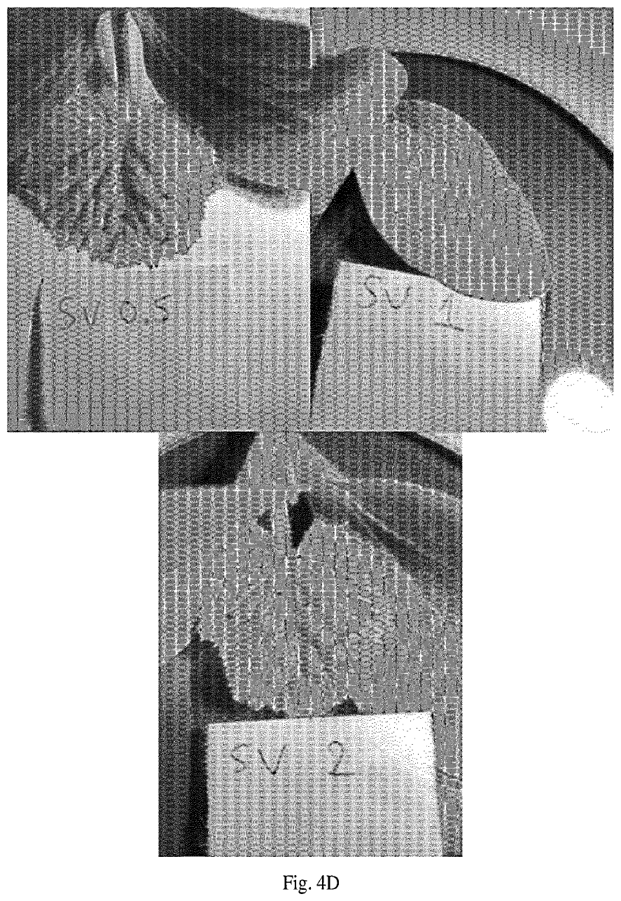

Susceptibility towards the above reported formulations was investigated using a topical bioassay. Pools of about ten wingless adult aphids were collected with a fine paintbrush from their rearing boxes and transferred inside the bioassay containers (ventilated plastic containers, 200 mL total volume), with a 5-days old pea seedling in the center (FIG. 5a).

Aphids were left for a few hours to settle onto the plants; after this period, those that did not walk on the plants were removed, whilst the others were individually treated using a micro-applicator (Hamilton PB600-1 Repeating Dispenser), carrying a Hamilton 1701 Series Gastight Syringe, to dispense 0.2 μL drops of formulated product or water (FIG. 5b).

Aphids were maintained at 21° C.±0.5° C. with a 16:8 light:dark photoperiod and mortality assessment was done 24, 48 and 72 hours after insecticide application (shortly “HAA”).

The dose to be applied was choose on the basis of a previous work.

### 2.4 Statistical Analysis

Mortality data recorded from each bioassay were pooled together and the efficacy (%) was calculated according to the Abbot's formula.

Percentages, after arcsin transformation, have been statistically analysed with oneway analysis of variance (SPSS release 25.0—procedure ONEWAY).

### 3. Results

The dose has been selected according to previous test results to get about 20% efficacy 24 HAA, 30% 48 HAA and 50% 72 HAA.

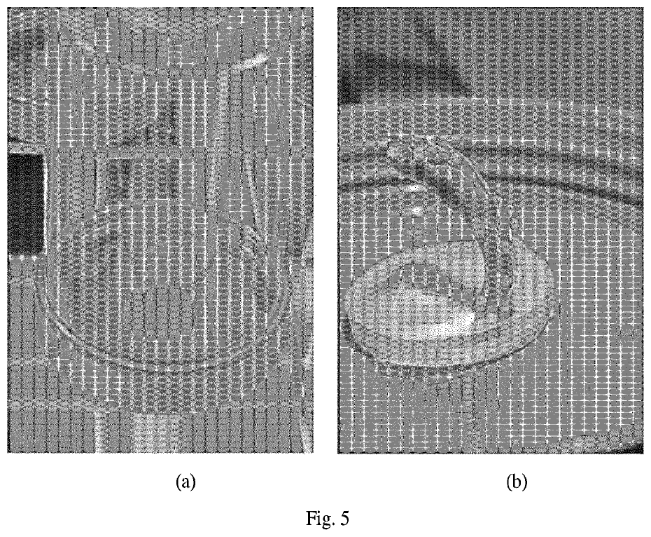

The mean efficacy measured in 4 replicates and at 3 end-points (24, 48 and 72 HAA) for the 3 different formulations are reported in the following tables and plotted in graph-in FIG. 6.

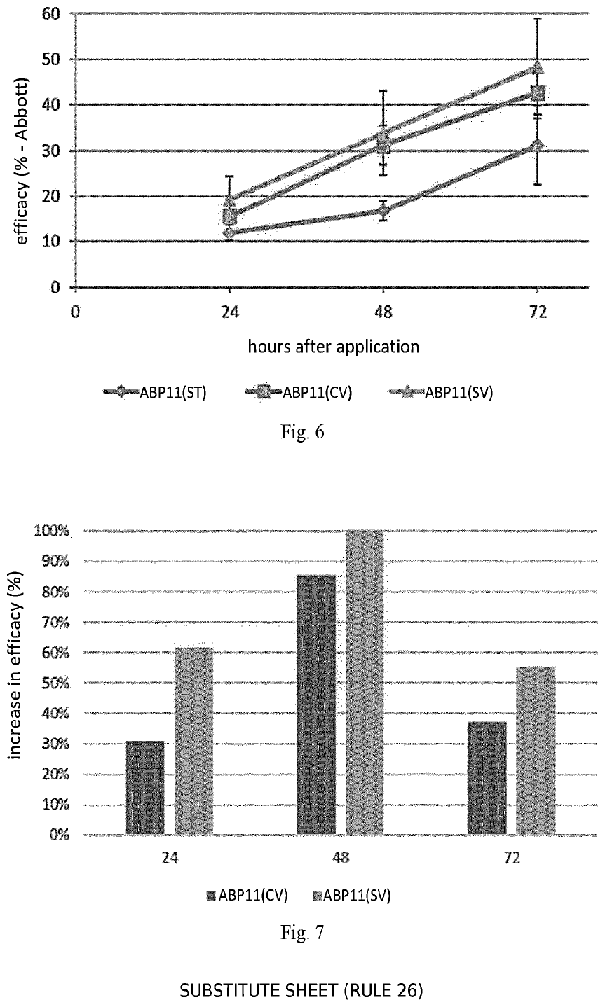

The mean efficacy for the applied dose of the formulation (ABP 111 SS) was slightly lower than the estimation of the previous baseline. Nevertheless, the two formulations (ABP 111 SV and ABP 111 CV) increased the efficacy against the Green Peach-Potato Aphid. The mean observed increases are reported in FIG. 7. The highest effect was observed 48 hours after the application (CV=85% and SV=101%) meanwhile 24 HAA and 72 HAA the efficacy variations were quite similar (31% and 37% respectively 24 and 72 HAA for CV formulation and 62% and 55% for SV formulation).

TABLE 1
Efficacy 24 hours after application of the 3 different formulations of ABP 111.

| | | | | | 95% Confidence Interval | | | |
|---|---|---|---|---|---|---|---|---|
| | | | | | for Mean | | | |
| | | | Std. | Std. | Lower | Upper | | |
| 24 HAA | N | Mean | Deviation | Error | Bound | Bound | Minimum | Maximum |
| ABP111(ST) | 4 | 11.93 | 4.10 | 2.05 | 5.41 | 18.45 | 9.42 | 18.05 |
| ABP111(CV) | 4 | 15.61 | 8.10 | 4.05 | 2.73 | 28.50 | 7.04 | 26.51 |
| ABP111(SV) | 4 | 19.27 | 12.83 | 6.42 | −1.15 | 39.69 | 5.08 | 35.86 |

TABLE 2
Efficacy 48 hours after application of the 3 different formulations of ABP 111.

| | | | | | 95% Confidence Interval | | | |
|---|---|---|---|---|---|---|---|---|
| | | | | | for Mean | | | |
| | | | Std. | Std. | Lower | Upper | | |
| 48 HAA | N | Mean | Deviation | Error | Bound | Bound | Minimum | Maximum |
| ABP111(ST) | 4 | 16.79 | 3.60 | 1.80 | 11.05 | 22.52 | 13.13 | 20.13 |
| ABP111(CV) | 4 | 31.14 | 11.02 | 5.51 | 13.60 | 48.68 | 15.85 | 39.39 |
| ABP111(SV) | 4 | 33.76 | 22.28 | 11.14 | −1.69 | 69.22 | 14.26 | 65.56 |

TABLE 3
Efficacy 72 hours after application of the 3 different formulations of ABP 111.

| | | | | | 95% Confidence Interval | | | |
|---|---|---|---|---|---|---|---|---|
| | | | | | for Mean | | | |
| | | | Std. | Std. | Lower | Upper | | |
| 72 HAA | N | Mean | Deviation | Error | Bound | Bound | Minimum | Maximum |
| ABP111(ST) | 4 | 31.12 | 20.77 | 10.38 | −1.93 | 64.17 | 6.19 | 48.33 |
| ABP111(CV) | 4 | 42.69 | 13.34 | 6.67 | 21.46 | 63.92 | 28.33 | 56.25 |
| ABP111(SV) | 4 | 48.34 | 25.95 | 12.97 | 7.05 | 89.63 | 17.45 | 80.13 |

The analysis of variance (ANOVA) do not point out any significant difference among the 3 formulation as reported in the table below where p value for the F statistic is always greater than 0.05.

TABLE 4
Results of one-way analysis of variance (df: degree of freedom;
F: statistic value; p: probability of F statistic)

| End-point | df | F | p |
|---|---|---|---|
| 24 HHA | 2; 9 | 0.497 | 0.624 |
| 48 HHA | 2; 9 | 1.693 | 0.238 |
| 72 HHA | 2; 9 | 0.789 | 0.483 |

### 4. Conclusions

On average, the efficacy increased from 31% up to 101%.

Both formulations ABP 111 SV and ABP 111 CV performed better than the formulation ABP 111 SS.

### Example 4

The following compositions were prepared, having the ingredients reported in the table below.

| | | | | tridecyl | castor oil |
|---|---|---|---|---|---|
| | linoleic | palmitoleic | olive | alcohol | ethoxylate |
| | acid | acid | oil | ethoxylate | oleate |
| Example 4A | 50 wt % | | 31 wt % | 19 wt % | |
| Example 4B | | 50 wt % | 31 wt % | | 19 wt % |
| Example 4C | 50 wt % | | 31 wt % | | 19 wt % |

### Example 5

The following compositions were prepared, having the ingredients reported in the table below.

| | | | | tridecyl | castor oil |
|---|---|---|---|---|---|
| | linoleic | palmitoleic | olive | alcohol | ethoxylate |
| | acid | acid | oil | ethoxylate | oleate |
| Example 5A | 51 wt % | | 27 wt % | 22 wt % | |
| Example 5B | | 51 wt % | 27 wt % | | 22 wt % |
| Example 5C | 51 wt % | | 27 wt % | | 22 wt % |

### Example 6

The following compositions were prepared, having the ingredients reported in the table below.

| | | γ- | | tridecyl | castor oil |
|---|---|---|---|---|---|
| | oleic | linolenic | colza | alcohol | ethoxylate |
| | acid | acid | oil | ethoxylate | oleate |
| Example 6A | 45 wt % | | 23 wt % | 32 wt % | |
| Example 6B | | 45 wt % | 23 wt % | | 32 wt % |
| Example 6C | 45 wt % | | 23 wt % | | 32 wt % |

### Example 7

The following compositions were prepared having the ingredients reported in the table below.

| | Mixture of | | | tridecyl | castor oil |
|---|---|---|---|---|---|
| | C18 fatty | canola | colza | alcohol | ethoxylate |
| | acids | oil | oil | ethoxylate | oleate |
| Example 7A | 50 wt % | | 31 wt % | 19 wt % | |
| Example 7B | 50 wt % | 31 wt % | | | 19 wt % |
| Example 7C | 50 wt % | | 31 wt % | | 19 wt % |

The compositions of Examples 4-7 have been tested according to the same procedure as set forth in Example 2.

By topic exposure, all the tested formulations at all the tested concentrations caused significant mortality towards the target pest, in comparison to the untreated control. The mortality caused by the tested formulations at different concentrations was comparable to the treated control (ABP 617 at 1%). Dead aphids showed necrotic body.

1. A pesticide composition comprising:
1) at least a C₁₂-C₂₄ fatty acid,
2) at least a vegetal oil, and
3) at least an ethoxylated or propoxylated surfactant, or at least a polyoxyethylene emulsifier, or a mixture thereof.

2. The pesticide composition of claim 1, wherein said 1) at least a C₁₂-C₂₄ fatty acid is at least C₁₆-C₂₀ fatty acid.

3. The pesticide composition of claim 1, wherein said 2) at least a vegetal oil is rapeseed oil, colza oil, soybean oil, seed oil, olive oil, wheat germ oil, palm oil, coconut oil, sesame oil, babassu oil, castor oil, peanut oil, cottonseed oil, hemp oil, grape seed oil, tea tree oil (melaleuca oil), linseed oil, walnut oil, poppy oil, maize oil, borage oil, kukui oil, sunflower oil, groundnut oil, canola oil, anchusa oil, or a mixture thereof, preferably is colza oil, sesame oil, or a mixture thereof.

4. The pesticide composition of claim 1, wherein said 3) at least an ethoxylated surfactant is a C₁₂-C₂₄ fatty acid salt of seed oil ethoxylate, a fatty alcohol ethoxylate, or a mixture thereof.

5. The pesticide composition of claim 1, wherein the weight ratio between the 1) at least a C₁₂-C₂₄ fatty acid and 2) at least a vegetal oil is of 1:2 to 5:1.

6. The pesticide composition of claim 1, wherein the weight ratio between the 2) at least a vegetal oil, and 3) at least an ethoxylated or propoxylated surfactant, or at least a polyoxyethylene emulsifier, or a mixture thereof, is of 1:2 to 5:1.

7. The pesticide composition of claim 1, wherein the weight ratio between the 1) at least a C₁₂-C₂₄ fatty acid, and 3) at least an ethoxylated or propoxylated surfactant, or at least a polyoxyethylene emulsifier, or a mixture thereof, is of 1:1 to 10:1.

8. The pesticide composition of claim 1, wherein the 1) at least a C₁₂-C₂₄ fatty acid is in an amount up to 70 wt %, based on the weight of the composition.

9. The pesticide composition of claim 1, wherein the 2) at least a vegetal oil is in an amount up to 50 wt %, based on the weight of the composition.

10. The pesticide composition of claim 1, wherein the 3) at least an ethoxylated or propoxylated surfactant, or at least a polyoxyethylene emulsifier, or a mixture thereof, is in an amount up to 30 wt %, based on the weight of the composition.

11. The pesticide composition of claim 1, comprising:
1) 40-60 wt % of at least a C₁₆-C₂₀ fatty acid,
2) 25-35 wt % of colza oil, sesame oil, or a mixture thereof, and
3) 15-25 wt % of at least an ethoxylated surfactant.

12. The pesticide composition of claim 11, comprising:
1) 48-53 wt % of oleic acid,
2) 28-33 wt % of colza oil, sesame oil, or a mixture thereof, and
3) 17-22 wt % of castor oil ethoxylate oleate, tridecyl alcohol ethoxylate, or a mixture thereof.

13. The pesticide composition of claim 1 comprising agro-chemical additives.

14. A method of protecting crop against pests, said method comprising the steps of:
i) providing a pesticide composition of claim 1,
ii) diluting the composition in water to obtain a diluted solution,
iii) applying the diluted solution to crop.

15. A process of preparing the pesticide composition of claim 1, said process comprising the steps of:
a) providing the components 1)-3), and
b) mixing until a pesticide composition in the form of a uniform emulsion is achieved.

16. The pesticide composition of claim 1, wherein said 1) at least C₁₂-C₂₄ acid is oleic acid.

17. The pesticide composition of claim 1, wherein said 3) at least an ethoxylated surfactant is castor oil, ethoxylate oleate, tridecyl alcohol ethoxylate, or a mixture thereof.

18. The pesticide composition of claim 1, wherein the weight ratio between the 1) at least a C₁₂-C₂₄ fatty acid and 2) at least a vegetable oil is 1:1.1 to 3.1.

19. The pesticide composition of claim 1, wherein the weight ratio between the 2) at least a vegetal oil, and 3) at least an ethoxylated or propoxylated surfactant, or at least a polyoxyethylene emulsifier, or a mixture thereof, is 1:1 to 3:1.

20. The pesticide composition of claim 1, wherein the weight ratio between the 1) at least a C₁₂-C₂₄ fatty acid, and 3) at least an ethoxylated or propoxylated surfactant, or at least a polyoxyethylene emulsifier, or a mixture thereof, is 2:1 to 5:1.
